(19) United States
(12) Patent Application Publication
(10) Pub. No.: US 2024/0034256 A1
(43) Pub. Date: Feb. 1, 2024

(54) TRANSFER OF DRIVER PROFILE FOR VARIOUS VEHICLES

(71) Applicant: PACCAR INC, Bellevue, WA (US)

(72) Inventor: Shreyas Vishal SINGARAVELU, Bellevue, WA (US)

(73) Assignee: PACCAR INC, Bellevue, WA (US)

(21) Appl. No.: 17/815,378

(22) Filed: Jul. 27, 2022

(51) Int. Cl. B60R 16/037; G07C 5/00; G07C 5/08; H04W 4/40

(52) U.S. Cl. CPC B60R 16/037; G07C 5/008; G07C 5/0816; H04W 4/40

(57) ABSTRACT

Systems and methods for transferring a driver profile between various vehicles. A driver profile is created in association with a driver of a first vehicle having a mobile device that executes a mobile application configured to communicate with and receive driver-adjusted configuration settings associated with operation of the first vehicle. The mobile application may store the adjusted configuration settings in the driver profile. The mobile application may be further configured to communicate with a plurality of other vehicles. In some examples, when the driver operates a second vehicle of the plurality of other vehicles, the mobile application can map the adjusted configuration settings in the driver profile to a set of adjusted configuration settings for the second vehicle. For example, the second vehicle may adjust various configuration settings of the second vehicle based on the received adjusted configuration settings.

### BACKGROUND

Vehicles typically have various configuration settings that can be adjusted by drivers to personalize the vehicles to the drivers' preferences. Some vehicles are able to store configuration settings for a minimal number of drivers (e.g., 2-4); however, adjusting the configuration settings for each driver and for each vehicle that each driver operates is not only time-consuming, but can cause wasted time for a driver each time the driver operates a new vehicle. As can be appreciated, this can be problematic, e.g., in various vehicle fleet scenarios, where multiple vehicles are operated by multiple drivers.

While relatively specific examples have been discussed, it should be understood that aspects of the present disclosure should not be limited to solving the specific examples identified in the background.

### SUMMARY

The disclosure generally relates to transferring a driver profile between various vehicles according to examples.

According to examples, a method is provided, comprising: creating a driver profile corresponding to a driver; receiving an indication of the driver operating a first vehicle at a first time; establishing a first communication link with the first vehicle receiving, via the first communication link, adjusted configuration settings associated with the first vehicle; storing the adjusted configuration settings associated with the first vehicle in the driver profile; receiving an indication of the driver operating a second vehicle at a second; establishing a second communication link with the second vehicle; determining the driver profile includes adjusted configuration settings that are mappable to configuration settings of the second vehicle; mapping the adjusted configuration settings in the driver profile to a set of adjusted configuration settings associated with the second vehicle; and providing the adjusted configuration settings associated with the second vehicle to the second vehicle via the second communication link to personalize the second vehicle to the driver.

According to examples, a system is provided, comprising: at least one processor; a memory including instructions, which when executed by the processor, cause the system to: create a driver profile corresponding to a driver; receive an indication of the driver operating a first vehicle at a first time; establish a first communication link with the first vehicle; receive, via the first communication link, adjusted configuration settings associated with the first vehicle; store the adjusted configuration settings associated with the first vehicle in the driver profile; receive an indication of the driver operating a second vehicle at a second time; establish a second communication link with the second vehicle; determine the driver profile includes adjusted configuration settings that are mappable to configuration settings of the second vehicle; map the adjusted configuration settings in the driver profile to a set of adjusted configuration settings associated with the second vehicle; and provide the adjusted configuration settings associated with the second vehicle to the second vehicle via the second communication link to personalize the second vehicle to the driver.

According to examples, a method is provided, comprising: receiving an indication of a driver operating a first vehicle at a first time; establishing a first communication link with a mobile computing device associated with the driver; receiving, a driver profile including a set of adjusted configuration settings associated with a second vehicle operated by the driver; receiving a set of mappings between configuration settings of the first vehicle and the second vehicle; and translating the adjusted configuration settings associated with a second vehicle to a set of translated configuration settings for the first vehicle.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following figures:

FIG. 1 is a block diagram illustrating an operating environment in which driver profile transfer may be implemented according to an example;

FIG. 2 is a flow diagram illustrating processing steps of a method that can be used to transfer a driver profile between various vehicles according to an example;

FIG. 3 is a block diagram illustrating example physical components of a computing device or system with which examples may be practiced.

### DETAILED DESCRIPTION

The following detailed description refers to the accompanying drawings. Wherever possible, the same reference numbers are used in the drawings and the following description to refer to the same or similar elements. While aspects of the present disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the present disclosure, but instead, the proper scope of the present disclosure is defined by the appended claims. The following detailed description is, therefore, not to be taken in a limiting sense.

As mentioned above, a vehicle typically has various configuration settings that can be adjusted by a driver to personalize the vehicle to the driver's preferences. For instance, the configuration settings may include various settings related to the driver's positioning while operating the vehicle, such as seat adjustment settings, steering wheel positioning settings, mirror positioning settings, etc. Other configuration settings may include settings related to various interfaces between the driver and the driver's environment (sometimes referred to herein as operator interface settings), such as cabin lighting settings, cabin temperature settings, sound level settings, user interface settings, such as vehicle menu settings, time settings, language settings, favorites instrumentation layout, shortcut button assignment, display brightness levels, radio tuning settings, etc. Other configuration settings may include settings related to operation of the vehicle, such as advanced driver assistance systems (ADAS) settings, autonomous driving (AD) settings, adaptive cruise control settings, shutdown timer settings, anti-theft settings, etc. Alternative and/or additional configuration settings are possible and are within the scope of the present disclosure. As can be appreciated, adjusting the various configuration settings that are available to a vehicle may be time-consuming.

In some examples, a driver may operate multiple vehicles. For instance, the driver may work for an enterprise that owns various vehicles. In some examples, the vehicles may include various types of vehicles. Each time the driver operates a different truck, the driver may spend an amount of time adjusting various configuration settings of the vehicle to personalize the vehicle to the driver. As can be appreciated, the time spent by the driver adjusting the configuration settings may translate into downtime of operation of the vehicle. Additionally, in some cases, a driver may not want to spend the time to adjust the configuration settings when operating a new vehicle, and may, therefore, not personalize various settings to the driver. In some examples, the various settings may include safety-related settings, and failure to adjust them properly may provide a less-than-optimally safe vehicle for the driver to operate.

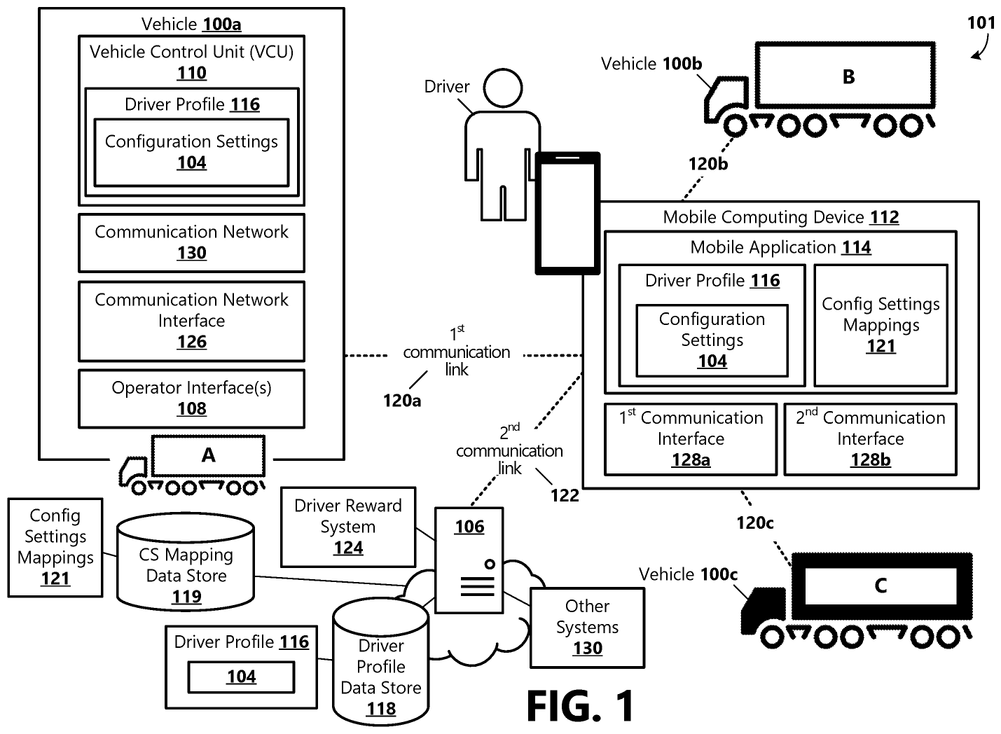

In examples, aspects of the present disclosure provide systems and methods for transferring a driver profile between various vehicles. According to examples, a driver profile is created in association with a driver of a first vehicle. The driver may have a mobile computing device (e.g., mobile phone, wearable device, tablet device) that executes a mobile application that is configured to communicate with the first vehicle and receive driver-adjusted configuration settings associated with operation of the first vehicle. The mobile application may further store the adjusted configuration settings in the driver profile. In some examples, the mobile application may be configured to communicate with a remote server to store, and later retrieve, the adjusted configuration settings. The mobile application may be further configured to communicate with each of a plurality of other vehicles. In some examples, when the driver operates a second vehicle of the plurality of other vehicles, the mobile application can map the adjusted configuration settings in the driver profile to a set of adjusted configuration settings for the second vehicle. For example, various configuration settings of the second vehicle may be adjusted based on the received adjusted configuration settings. These and other examples are discussed below with reference to FIGS. 1-3.

FIG. 1 is a block diagram illustrating an example operating environment 101 in which driver profile transfer may be implemented. With reference now to FIG. 1, the example operating environment 101 includes a mobile computing device 112 operated by a driver of a plurality of vehicles 100a-c (collectively, vehicles 100). The mobile computing device 112, for example, may include a mobile phone, laptop, wearable device, tablet device, or other mobile device operative to execute a mobile application 114 and communicate with the vehicles 100. Although FIG. 1 depicts three vehicles 100, in other examples, fewer (e.g., 2) or more (e.g., 4+) vehicles 100 may be operated by the driver. Additionally, while the vehicles 100 are depicted as trucks, in other examples, the vehicle 100 may be one of various types of vehicles, such as, but not limited to: a car, motorcycle, recreational vehicle, construction equipment, farm equipment, aircraft, or other type of vehicle capable of carrying at least one human passenger (including a driver of the vehicle). As depicted, each vehicle 100 may include a vehicle control unit (VCU) 110, a communication network 130, a communication network interface 126, and one or more operator interfaces 108. The communication network 130, for example, may include a bus including one or more bus standards, switches, and networks, including but not limited to Ethernet, Communications Area Network (CAN), FlexRay, 12C buses, PC Express buses, etc. In some examples, the VCU 110 may operate as an in-vehicle computing device for managing the collection and dissemination of information.

In some examples, the VCU 110 may collect and transmit information over the communication network 130 to/from various vehicle components and process the information for controlling operation of the vehicle, controlling various operator interfaces 108 (e.g., graphical display(s) and other components of the vehicle with which the driver may interface in the driver's environment during operation of the vehicle), displaying appropriate information to the driver via an operator interface 108, such as a graphical display, and other vehicle operations. In some examples, the VCU 110 may receive driver input via driver interaction with an operator control input of an operator interface 108. Some non-limiting examples of operator control input of an operator interface 108 may include a touchscreen, buttons, knobs, or other controls for adjusting, (e.g., via the driver's touch, voice, or gesture) a seat, mirror, steering wheel, temperature, lighting brightness, sound level, the graphical display, and/or other environmental factors related to the driver while operating the vehicle 100.

In some examples, the VCU 110 may further collect and transmit information over a first wireless communication link 120a-c (collectively, first communication link 120) to/from the mobile application 114 operating on the driver's mobile computing device 112. The first communication link 120 may include a short-range wireless communication channel established between the vehicle 100 and the mobile computing device 112. In some examples, the first communication link 120 is a personal area network (PAN), such as a BLUETOOTH communication link. For example, the mobile computing device 112 may include a first communication interface 128a (e.g., a BLUETOOTH interface) that may operate to communicate with and establish the first communication link 120 with the vehicle 100 via a corresponding network communication interface 126 (e.g., a BLUETOOTH interface) included in the vehicle 100. Other examples of a first communication link 120 are possible and contemplated, including, without limitation, WiFi, ZigBee, near-field communication (NFC), etc.

According to examples, the collected, processed, and/or transmitted information may include various configuration settings 104 that may be adjusted to personalize the vehicle 100 to the driver's preferences. For instance, the various configuration settings 104 may include various settings related to the driver's positioning while operating the vehicle 100, such as seat adjustment settings, steering wheel positioning settings, mirror positioning settings, etc. Other configuration settings 104 may include various operator interface settings, such as cabin lighting settings, cabin temperature settings, sound level settings, vehicle menu settings, time settings, language settings, favorites instrumentation layout, shortcut button assignment, display brightness levels, radio tuning settings, etc. Other configuration settings 104 may include settings related to operation of the vehicle 100 via one or more vehicle systems. Such operational settings may include advanced driver assistance systems (ADAS) settings, autonomous driving (AD) settings, adaptive cruise control settings, shutdown timer settings, anti-theft settings, etc. In some examples, when operating a vehicle 100, the driver may adjust one or more of the various configuration settings 104, for example, from a default setting or previous setting to a setting personalized to the driver. For instance, adjustments may be made via driver interaction with one or more operator interfaces 108. The adjustments to the configuration settings 104, which may sometimes be referred to herein as driver-adjusted configuration settings 104, may personalize the vehicle 100 to the driver and put the vehicle 100 in a ready-to-operate condition for the driver.

According to an example implementation, one or more driver-adjusted configuration settings 104 may be stored in a custom data file that includes various fields for receiving and storing information corresponding to the driver. The custom data file may herein be referred to as a driver profile 116. In some examples, the one or more driver-adjusted configuration settings 104 may be stored in association with a particular vehicle 100 and/or a particular vehicle type (e.g., make, model). The driver profile 116 may further store a driver identifier (ID) associated with the driver. In some examples, the driver profile 116 may store additional information about the driver, such as the driver's name, and/or other information about the driver. Each of a number of different drivers (including the driver of vehicle 100) may be associated with a different driver profile.

In some examples, the driver profile 116 may be created by the VCU 110 of a first vehicle 100a in response to receiving driver input via driver interaction with an operator control input of an operator interface 108, such as via a menu option provided by a display screen included in the first vehicle 100a. In other examples, the driver profile 116 may be created in response to receiving driver input via driver interaction with the mobile application 114. For instance, the mobile application 114 may be configured to allow the driver to create the driver profile 116 via inputs and/or selections made via the mobile application 114. Based on the obtained input, the mobile application 114 may create the driver profile 116.

In some example implementations, the VCU 110 may be configured to store one or more driver-adjusted configuration settings 104 in the driver's driver profile 116. In other example implementations, the VCU 110 may be configured to communicate with the mobile application 114, which may be configured to store one or more driver-adjusted configuration settings 104 in the driver's driver profile 116. For instance, the mobile application 114 may obtain and/or transmit driver profile information (e.g., driver-adjusted configuration settings 104) with the VCU 110 via the first communication link 120. In some examples, when the driver's mobile computing device 112 is within shortrange wireless communication range of the first vehicle 100a, a connection (e.g., the first communication link 120) may be established between the driver's mobile computing device 112 and the first vehicle 100a. In some examples, the driver's identity may first be authenticated before establishing the first communication link 120.

In some examples, the mobile computing device 112 may include a second communication interface 128b that may enable communication with remote resources over one or a combination of Internet Protocol (IP)-based networks (e.g., a second communication link 122). In examples, second communication ink 122 may comprise WiFi, a cellular network, the Internet, a wide area network, or otherwise. The mobile application 114 may be configured to communicate with a remote server 106 that includes or has access to a driver profile data store 118. The mobile application 114, for example, may transmit and obtain driver profile information (e.g., driver-adjusted configuration settings 104) to/from the driver profile data store 118. For instance, the driver profile data store 118 may include a database operative to store, and make accessible, driver profiles 116 for each of a plurality of different drivers (including the driver of vehicle 100).

As mentioned above, the driver-adjusted configuration settings 104 in the driver's driver profile 116 may be stored in association with the first vehicle 100a. According to examples, the mobile application 114 may be configured to communicate with the VCU 110 of another vehicle 100 (e.g., a second vehicle 100b and/or a third vehicle 100c). For example, the driver may operate the second vehicle 100b and/or the third vehicle 100c at another time, and a first communication link 120b may be selectively established between the driver's mobile computing device 112 and the second vehicle 100b and/or third vehicle 100c when the driver's mobile computing device 112 is within communication range (e.g., shortrange wireless communication range) of the second vehicle 100b and/or third vehicle 100c. Via a first communication link 120b, 120c established between the driver's mobile computing device 112 and the second vehicle 100b and/or third vehicle 100c, the VCU 110 of the second vehicle 100b and/or third vehicle 100c may obtain driver profile information associated with the driver. The driver profile information, for example, may include the driver-adjusted configuration settings 104 received in association with the first vehicle 100a.

For example, the VCU 110 of the second vehicle 100b and/or third vehicle 100c may use the driver profile information to adjust the configuration settings 104 of the second vehicle 100b and/or third vehicle 100c to match or correspond to the driver-adjusted configuration settings 104 made in association with the first vehicle 100a. In some examples, the first vehicle 100a and the second vehicle 100b are the same vehicle. For instance, the driver-adjusted configuration settings 104 made in association with the first vehicle 100a may be transmitted by the mobile application 114 to the first/second vehicle 100a/100b to prepare the first/second vehicle 100a/100b into operating condition for the same user a second time. For instance, the seat, mirrors, lighting, graphical display, configurable operator control inputs, radio, and/or other configurable components of the first/second vehicle 100a/100b may be automatically adjusted based on the driver profile information received from the mobile application 114.

In other examples, the second vehicle 100b is a different vehicle, but may be of a same make and model as the first vehicle 100a. For instance, the driver-adjusted configuration settings 104 made in association with the first vehicle 100a may map directly to configuration settings 104 for the second vehicle 100b. Thus, when the driver operates the second vehicle 100b, the driver-adjusted configuration settings 104 made in association with the first vehicle 100a may be transmitted by the mobile application 114 to the second vehicle 100b and used by the VCU 110 of the second vehicle 100b to adjust the default or previous configuration settings 104 of the second vehicle 100b to match the first vehicle settings. For instance, the seat, mirrors, lighting, graphical display, configurable operator control inputs, radio, and/or other configurable components of the second vehicle 100b may be automatically adjusted to match the driver profile information received from the mobile application 114.

In some examples, the third vehicle 100c is a different vehicle, and may be of a different make and/or model as the first vehicle 100a. For instance, one or more of the driver-adjusted configuration settings 104 made in association with the first vehicle 100a may not map directly to configuration settings 104 for the third vehicle 100c. As an example, a range of selectable heights of the driver seat in the first vehicle 100a may be different from a range of selectable heights of the driver seat in the third vehicle 100c. In some examples, the range of heights may correspond to a variable between the first vehicle 100a and the third vehicle 100c, such as a line-of-sight angle with respect to a viewing angle of the driver over a hood or front part of the vehicle 100, distance to a floorboard and/or pedals, etc. Thus, based on known or estimated values of the variables, the mobile application 114 may be configured to translate the height of the driver seat in the first vehicle 100a into a corresponding height of the driver seat in the third vehicle 100c. As can be appreciated, the mobile application 114 may be configured to translate additional and/or other configuration settings 104 based on additional/other variables between different vehicles 100. In some examples, the mobile application 114 may store mappings between configuration setting variables of various types of vehicles 100. In other examples, the mappings may be stored remotely and relevant mappings may be accessed by the mobile application 114.

For example, the mobile application 114 may communicate with a server 106 that includes or has access to a mappings data store 119 configured to store and make available mappings between configuration setting variables of various types of vehicles 100, such as the first vehicle 100a and the third vehicle 100c. These mappings may sometimes be referred to herein as configuration settings mappings 121. Thus, when the driver operates the third vehicle 100c, the mobile application 114 may, in some examples, access configuration setting mappings 121 from the mappings data store 119. As an example, when the driver operates the third vehicle 100c for a first time, the mobile application 114 may request and obtain driver profile information associated with the driver, including driver-adjusted configuration settings 104 for another vehicle 100, such as the first vehicle 100a. Additionally, the mobile application 114 may access or may request and obtain mapping information (e.g., configuration settings mappings 121) for the driver-adjusted configuration settings 104 associated with the first vehicle 100a. In some examples, the mobile application 114 may be further configured to use the mapping information to translate the one or more driver-adjusted configuration settings 104 associated with the first vehicle 100a into a set of translated driver-adjusted configuration settings 104 associated with the third vehicle 100c. These translated driver-adjusted configuration settings 104 may be transmitted by the mobile application 114 to the third vehicle 100c via the first communication link 120c established between the driver's mobile computing device 112 and the third vehicle 100c. For example, the translated configuration settings 104 may be included in driver profile information provided to the VCU 110 via the first communication link 120c. In examples, the mapping information may be configured to place a driver in a relatively similar or same position in the third vehicle 100c as the driver was in while in the first vehicle 100a (e.g., same distance from a front edge of the seat to the pedals, same angle of sight over a visible hood edge, etc.). Even when the mapping information cannot (due to differences between the first vehicle 100a and the third vehicle 100c) place the driver in a same position in all respects, the mapping information may prioritize certain relative positions over others and/or place the driver in a similar enough position in the third vehicle 100c that additional adjustments are needed by the driver.

In other examples, the mobile application 114 may transmit relevant mapping information to the VCU 110, which may be configured to use the mapping information to translate the one or more driver-adjusted configuration settings 104 associated with the first vehicle 100a (e.g., included in driver profile information associated with the driver) into a set of translated driver-adjusted configuration settings 104 associated with the third vehicle 100c.

According to examples, the translated configuration settings 104 may be used by the VCU 110 to adjust the default or previous configuration settings 104 of the third vehicle 100c to match (to the extent possible) or correspond to the first vehicle settings. For instance, the seat, mirrors, lighting, graphical display, configurable operator control inputs, radio, and/or other configurable components of the third vehicle 100c may be automatically adjusted to match or be generally similar to the driver-adjusted configuration settings 104 associated with the first vehicle 100a received from the mobile application 114.

In some examples, the translated configuration settings 104 may be saved in the driver's driver profile 116 by the mobile application 114 as driver-adjusted configuration settings 104 in association with the third vehicle 100c. In some examples, while operating the third vehicle 100c, the driver may make one or more adjustments to the configuration settings 104. These driver-adjusted configuration settings 104 may be transmitted to the mobile application 114, which may update the previously saved/stored driver-adjusted configuration settings 104 associated with the third vehicle 100c.

In some examples, one or more driver-adjusted configuration settings 104 associated with the first vehicle 100a may not be translatable to a translated configuration setting 104 for the third vehicle 100c. In other examples, translated configuration settings 104 may not be available for one or more configuration settings 104 associated with the third vehicle 100c. For instance, the first vehicle 100a may not have a feature with which the third vehicle 100c is equipped, or vice versa. When a translation is not provided for a configuration setting 104, the VCU 110, for example, may leave the configuration setting 104 in at its default or previous setting. In some examples, the VCU 110 may cause a graphical display in the third vehicle 100c to display a menu where the configuration setting 104 may be adjusted by the driver.

In some examples, additional information may be received by the mobile application 114 from a vehicle 100 via the first communication link 120 and included in the driver profile 116 corresponding to the driver, such as driver-specific trip summary information associated with operation of the vehicle while being operated by the driver. For instance, driver-specific trip summary information may include information associated with fuel efficiency, traffic law obedience, etc., and/or other driver behaviors that may be determined as positive behaviors that may be rewarded. In some examples, the mobile application 114 may include driver-specific trip summary information in driver profile information transmitted to the server 106 to be stored in the driver profile data store 118. In some examples, the driver-specific trip summary information included in the driver's driver profile 116 may be accessed by a driver rewards system 124 configured to determine driver rewards based on received driver-specific trip summary information associated with operation of one or more vehicles 100 during one or more times of operation. In other examples, the mobile application 114 may communicate with a server 106 that includes or has access to the driver rewards system 124. In other examples, the mobile application 114 may communicate with other systems 130.

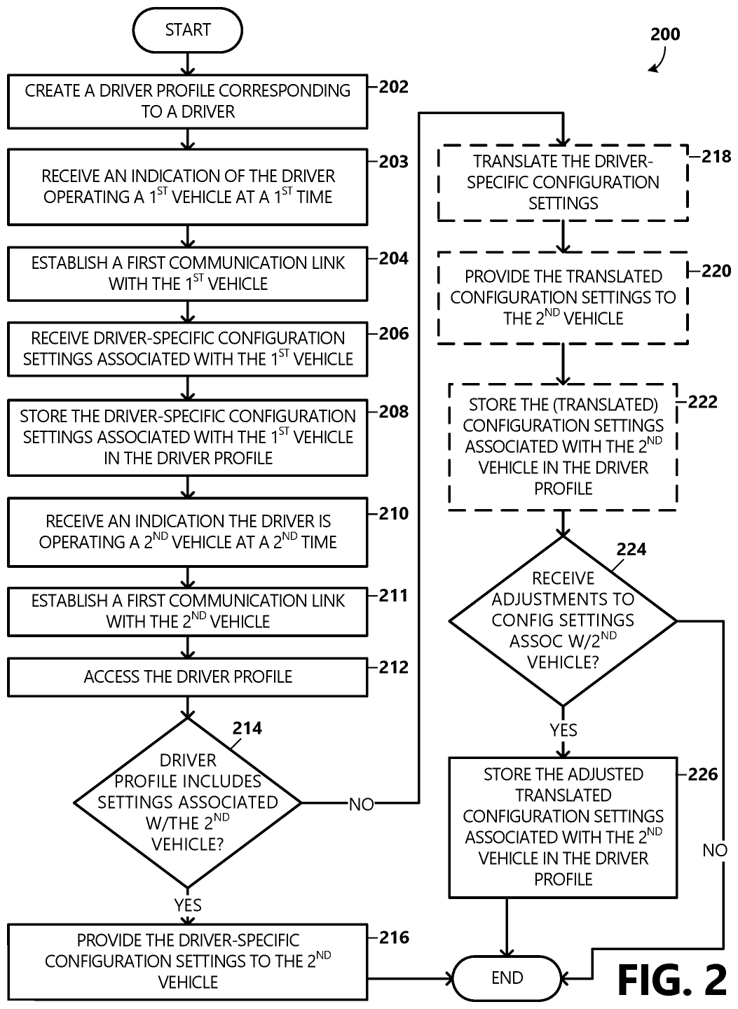

With reference now to FIG. 2, a flow diagram is provided illustrating example processing steps of a method 200 that can be used to transfer driver profile information between various vehicles 100 according to an example. At operation 202, a driver profile 116 corresponding to a particular driver may be created. The driver profile 116 may include a driver ID. In some examples, the driver profile 116 may be created using a mobile application 114 operating on the driver's mobile computing device 112. In other examples, the driver profile 116 may be created by the VCU 110 of a vehicle 100 being operated by the driver in response to interaction with a graphical display or other driver interface 108 on the vehicle 100.

At operation 203, an indication of the driver operating a first vehicle 100a at a first time may be received. According to one example implementation, operation of the vehicle 100 may be initiated when an ignition of the vehicle 100 is switched into a particular position or setting (e.g., an accessory or electronics on position/setting), and may end when the ignition of the vehicle 100 is switched into an off position/setting. In other examples, operation of the vehicle 100 may be initiated when the mobile computing system 112 is brought within range (e.g., within the cabin) of the vehicle 100, among other possibilities.

At operation 204, the first communication link 120a may be selectively established. For example, the communication network interface 126 of the first vehicle 100a may be configured to transmit a signal that may be received by the first communication interface 128a of the driver's mobile computing device 112 when the driver's mobile computing device 112 is within short-range wireless communication range of the first vehicle 100a. In some examples, an option to establish a first communication link 120a with the first vehicle 100a may be presented on the driver's mobile computing device 112, which may be selected by the driver. In other examples, an option to establish the first communication link 120a with the driver's mobile computing device 112 may be presented on a graphical display of the first vehicle 100a, which may be selected by the driver. As mentioned above, the first communication link 120a may be a BLUETOOTH communication link. In some examples, the driver's identity may be authenticated prior to establishing the first communication link 120a.

During operation of the first vehicle 100a by the driver, one or more configuration settings of the first vehicle 100a may be adjusted by the driver. At operation 206, during and/or after operation of the first vehicle 100a, one or more of the driver-adjusted configuration settings may be transmitted to and received by the mobile application 114 via the first communication link 120a. In some examples, driver-specific trip summary information associated with operation of the first vehicle 100a during the first time while being operated by the driver may be transmitted to and received by the mobile application 114 via the first communication link 120a.

At operation 208, the received information may be stored in the driver's driver profile 116. For example, the mobile application 114 may store the one or more of the driver-adjusted configuration settings and trip summary information, if provided, in association with the first vehicle 100a in the driver profile 116 stored on the mobile application 114. In some examples, the mobile application 114 may further transmit the updated driver profile information, which may include trip summary information, to the server 106 via a second communication link 122.

At operation 210, an indication of the driver operating another vehicle 100 (e.g., a second vehicle 100b) at a second time may be received. For example, when the driver's mobile computing device 112 is within short-range wireless communication range of the second vehicle 100b, an option to establish a first communication link 120b with the second vehicle 100b may be presented on the driver's mobile computing device 112. In other examples, an option to establish the first communication link 120b with the driver's mobile computing device 112 may be presented on a graphical display of the second vehicle 100b.

At operation 211, the first communication link 120b may be selectively established, and at operation 212, the driver profile 116 associated with the driver may be accessed from storage. The storage may include local storage on the mobile computing device 112 and/or a remote driver profile data store 118 accessed via a second communication link 122, such as an IP-based network. At decision operation 214, a determination may be made as to whether information included in the driver profile includes driver-adjusted configuration settings 104 associated with the second vehicle 100b. For example, the mobile application 114 may receive information identifying the second vehicle 100b when establishing the first communication link 120b with the second vehicle 100b. In some examples, the determination may be based on whether driver-adjusted configuration settings 104 included in the driver profile 116 are associated with a same type (e.g., make and model) of vehicle as the second vehicle 100b. In other examples, the determination may be based on whether the driver-adjusted configuration settings 104 in the driver profile 116 are directly mappable to configuration settings 104 for the second vehicle 100b. For example, one or more available adjustable configuration settings 104 in the second vehicle 100b may match one or more driver-adjusted configuration settings 104 stored in the driver profile 116, such as driver-adjusted configuration settings 104 stored in association with the driver operating the first vehicle 100a.

When a determination is made that the driver profile information includes driver-adjusted configuration settings 104 associated with the second vehicle 100b, at operation 216, the driver-adjusted configuration settings 104 may be transmitted to the VCU 110 of the second vehicle 100b via the first communication link 120b. For example, the driver-adjusted configuration settings 104 to automatically adjust one or more configuration settings 104 of the second vehicle 100b based on the received driver-adjusted configuration settings 104. The VCU 110 of the second vehicle 100b may prepare the second vehicle 100b into operating condition for the same user. For instance, the seat, mirrors, lighting, graphical display, configurable operator control inputs, radio, and/or other configurable components of the second vehicle 100b may be automatically adjusted based on the driver profile information received from the mobile application 114.

Alternatively, when a determination is made that the driver profile information does not include driver-adjusted configuration settings 104 associated with the second vehicle 100b, at optional operation 218, one or more driver-adjusted configuration settings 104 included in the driver profile 116 may be translated into configuration settings 104 that match or correspond to the driver-adjusted configuration settings 104 associated with another vehicle 100, such as the first vehicle 100a. For example, a set of translated configuration settings 104 may be generated based on a configuration settings mappings 121 that may map one or more of the driver-adjusted configuration settings 104 associated with the first vehicle 100a to one or more matching (if possible) or corresponding configuration settings 104 for the second vehicle 100b.

At optional operation 220, the translated configuration settings 104 may be provided to the second vehicle 100b. For example, the mobile application 114 may be provided to the second vehicle 100b via the first communication link 120b. For example, the translated configuration settings 104 may be used by the VCU 110 to automatically adjust one or more configuration settings 104 of the second vehicle 100b based on the received translated configuration settings 104. The VCU 110 of the second vehicle 100b may prepare the second vehicle 100b into operating condition for the same user. For instance, the seat, mirrors, lighting, graphical display, configurable operator control inputs, radio, and/or other configurable components of the second vehicle 100b may be automatically adjusted based on the translated configuration settings 104 received from the mobile application 114.

At optional operation 222, the translated configuration settings 104 associated with the second vehicle 100b may be stored as configuration settings 104 associated with the second vehicle 100b in the driver's driver profile 116.

At decision operation 224, a determination may be made as to whether driver-specific configuration settings 104 may be received for the second vehicle 100b during and/or after operation of the second vehicle 100b. For instance, when one or more of the driver-adjusted configuration settings are transmitted to and received by the mobile application 114 via the first communication link 120b, at operation 226, the driver-adjusted configuration settings 104 may be stored in the driver profile 116. For example, the driver profile 116 may include a first set of configuration settings 104 associated with the first vehicle 100a and a second set of configuration settings 104 associated with the second vehicle 100b. In some examples, the first set of configuration settings 104 and the second set of configuration settings 104 may be stored as separate driver profile files, but linked by the driver ID for the driver.

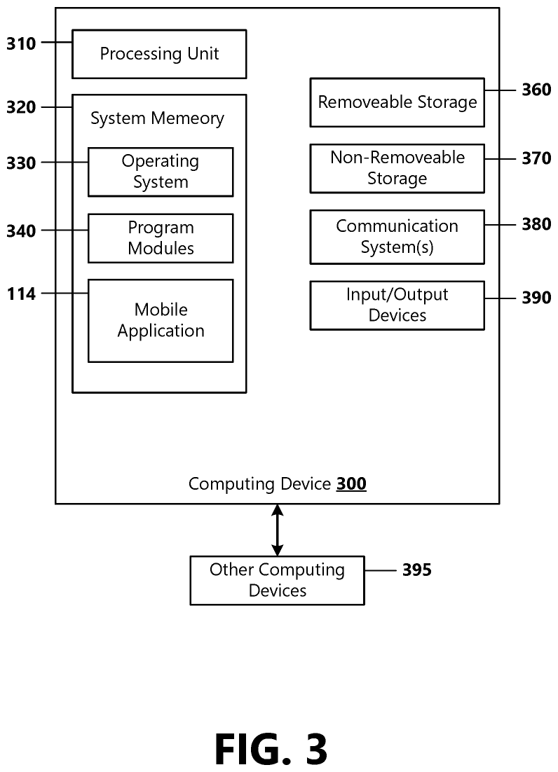

FIG. 3 is a block diagram illustrating physical components of an example computing device with which aspects may be practiced. The computing device 600 may include at least one processing unit 302 and a system memory 304. The system memory 304 may comprise, but is not limited to, volatile (e.g. random access memory (RAM)), non-volatile (e.g. read-only memory (ROM)), flash memory, or any combination thereof. System memory 304 may include operating system 306, one or more program instructions 308, and may include sufficient computer-executable instructions for the mobile application 114, which when executed, perform functionalities as described herein. Operating system 306, for example, may be suitable for controlling the operation of computing device 300. Furthermore, aspects may be practiced in conjunction with a graphics library, other operating systems, or any other application program and is not limited to any particular application or system. This basic configuration is illustrated by those components within a dashed line 310. Computing device 300 may also include one or more input device(s) 312 (keyboard, mouse, pen, touch input device, etc.) and one or more output device(s) 314 (e.g., display, speakers, a printer, etc.).

The computing device 300 may also include additional data storage devices (removable or non-removable) such as, for example, magnetic disks, optical disks, or tape. Such additional storage is illustrated by a removable storage 316 and a non-removable storage 318. Computing device 300 may also contain a communication connection 320 that may allow computing device 300 to communicate with other computing devices 322, such as over a network in a distributed computing environment, for example, an intranet or the Internet. Communication connection 320 is one example of a communication medium, via which computer-readable transmission media (i.e., signals) may be propagated.

Programming modules may include routines, programs, components, data structures, and other types of structures that may perform particular tasks or that may implement particular abstract data types. Moreover, aspects may be practiced with other computer system configurations, including hand-held devices, multiprocessor systems, microprocessor-based or programmable user electronics, minicomputers, mainframe computers, and the like. Aspects may also be practiced in distributed computing environments where tasks are performed by remote processing devices that are linked through a communications network. In a distributed computing environment, programming modules may be located in both local and remote memory storage devices.

Furthermore, aspects may be practiced in an electrical circuit comprising discrete electronic elements, packaged or integrated electronic chips containing logic gates, a circuit using a microprocessor, or on a single chip containing electronic elements or microprocessors (e.g., a system-on-a-chip (SoC)). Aspects may also be practiced using other technologies capable of performing logical operations such as, for example, AND, OR, and NOT, including, but not limited to, mechanical, optical, fluidic, and quantum technologies. In addition, aspects may be practiced within a general purpose computer or in any other circuits or systems.

Aspects may be implemented as a computer process (method), a computing system, or as an article of manufacture, such as a computer program product or computer-readable storage medium. The computer program product may be a computer storage medium readable by a computer system and encoding a computer program of instructions for executing a computer process. Accordingly, hardware or software (including firmware, resident software, micro-code, etc.) may provide aspects discussed herein. Aspects may take the form of a computer program product on a computer-usable or computer-readable storage medium having computer-usable or computer-readable program code embodied in the medium for use by, or in connection with, an instruction execution system.

Although aspects have been described as being associated with data stored in memory and other storage mediums, data can also be stored on or read from other types of computer-readable media, such as secondary storage devices, like hard disks, floppy disks, flash drives, or a CD-ROM, or other forms of RAM or ROM. The term computer-readable storage medium refers only to devices and articles of manufacture that store data or computer-executable instructions readable by a computing device. The term computer-readable storage media does not include computer-readable transmission media.

Aspects of the present invention may be used in various distributed computing environments where tasks are performed by remote processing devices that are linked through a communications network.

Aspects of the invention may be implemented via local and remote computing and data storage systems. Such memory storage and processing units may be implemented in a computing device. Any suitable combination of hardware, software, or firmware may be used to implement the memory storage and processing unit. For example, the memory storage and processing unit may be implemented with computing device 300 or any other computing devices 322, in combination with computing device 300, wherein functionality may be brought together over a network in a distributed computing environment, for example, an intranet or the Internet, to perform the functions as described herein. The systems, devices, and processors described herein are provided as examples; however, other systems, devices, and processors may comprise the aforementioned memory storage and processing unit, consistent with the described aspects.

The description and illustration of one or more aspects provided in this application are intended to provide a thorough and complete disclosure of the full scope of the subject matter to those skilled in the art and are not intended to limit or restrict the scope of the invention as claimed in any way. The aspects, examples, and details provided in this application are considered sufficient to convey possession and enable those skilled in the art to practice the best mode of the claimed invention. Descriptions of structures, resources, operations, and acts considered well-known to those skilled in the art may be brief or omitted to avoid obscuring lesser known or unique aspects of the subject matter of this application. The claimed invention should not be construed as being limited to any embodiment, aspects, example, or detail provided in this application unless expressly stated herein. Regardless of whether shown or described collectively or separately, the various features (both structural and methodological) are intended to be selectively included or omitted to produce an embodiment with a particular set of features. Further, any or all of the functions and acts shown or described may be performed in any order or concurrently. Having been provided with the description and illustration of the present application, one skilled in the art may envision variations, modifications, and alternate embodiments falling within the spirit of the broader aspects of the general inventive concept provided in this application that do not depart from the broader scope of the present disclosure.

We claim:

1. A method, comprising:
creating a driver profile corresponding to a driver;
receiving an indication of the driver operating a first vehicle at a first time;
establishing a first communication link with the first vehicle;
receiving, via the first communication link, adjusted configuration settings associated with the first vehicle;
storing the adjusted configuration settings associated with the first vehicle in the driver profile;
receiving an indication of the driver operating a second vehicle at a second;
establishing a second communication link with the second vehicle;
determining the driver profile includes adjusted configuration settings that are mappable to configuration settings of the second vehicle;
mapping the adjusted configuration settings in the driver profile to a set of adjusted configuration settings associated with the second vehicle; and
providing the adjusted configuration settings associated with the second vehicle to the second vehicle via the second communication link to personalize the second vehicle to the driver.

2. The method of claim 1, wherein:
determining the driver profile includes adjusted configuration settings that are mappable to configuration settings of the second vehicle comprises determining the second vehicle is a same type of vehicle as the first vehicle; and
providing the adjusted configuration settings to the second vehicle comprises providing the adjusted configuration settings associated with the first vehicle to the second vehicle.

3. The method of claim 1, wherein determining the driver profile includes adjusted configuration settings that are mappable to configuration settings of the second vehicle comprises:
determining the second vehicle is a different type of vehicle as the first vehicle;
accessing a set of configuration setting mappings; and
determining the set of configuration setting mappings includes mappings between configuration settings of the first vehicle and the second vehicle.

4. The method of claim 3, further comprising using the mappings to translate one or more adjusted configuration settings associated with the first vehicle to a corresponding set of translated configuration settings for the second vehicle.

5. The method of claim 3, wherein providing the adjusted configuration settings to the second vehicle comprises providing the mappings to the second vehicle to be translated into a set of translated configuration settings for the second vehicle.

6. The method of claim 1, further comprising storing adjusted configuration settings associated with the second vehicle as adjusted configuration settings associated with the second vehicle in the driver profile.

7. The method of claim 6, further comprising:
receiving, via the second communication link, adjusted configuration settings associated with the second vehicle; and
updating the adjusted configuration settings associated with the second vehicle stored in the driver profile.

8. The method of claim 1, further comprising:
receiving, from the first vehicle, driver-specific trip summary information associated with operation of the first vehicle;
including the driver-specific trip summary information associated with operation of the first vehicle in the driver profile;
receiving, from the second vehicle, driver-specific trip summary information associated with operation of the second vehicle; and
including the driver-specific trip summary information associated with operation of the second vehicle in the driver profile.

9. The method of claim 8, further comprising transmitting the driver profile to a driver rewards system operative to reward drivers for positive driving behaviors based on an evaluation of driver-specific trip summary information associated with the driver over a plurality of time periods.

10. The method of claim 1, further comprising:
transmitting the driver profile to a cloud server; and
accessing the driver profile from the cloud server.

11. A system, comprising:
at least one processor;
a memory including instructions, which when executed by the processor, cause the system to:
create a driver profile corresponding to a driver;
receive an indication of the driver operating a first vehicle at a first time;
establish a first communication link with the first vehicle;
receive, via the first communication link, adjusted configuration settings associated with the first vehicle;
store the adjusted configuration settings associated with the first vehicle in the driver profile;
receive an indication of the driver operating a second vehicle at a second time;
establish a second communication link with the second vehicle;
determine the driver profile includes adjusted configuration settings that are mappable to configuration settings of the second vehicle;
map the adjusted configuration settings in the driver profile to a set of adjusted configuration settings associated with the second vehicle; and
provide the adjusted configuration settings associated with the second vehicle to the second vehicle via the second communication link to personalize the second vehicle to the driver.

12. The system of claim 11, wherein:
the second vehicle is a same type of vehicle as the first vehicle; and
the adjusted configuration settings associated with the second vehicle include adjusted configuration settings associated with the first vehicle.

13. The system of claim 11, wherein when the second vehicle is a different type of vehicle as the first vehicle, the instructions cause the system to:
access a set of configuration setting mappings; and
determine the set of configuration setting mappings includes mappings between configuration settings of the first vehicle and the second vehicle.

14. The system of claim 13, wherein the instructions cause the system to use the mappings to translate one or more adjusted configuration settings associated with the first vehicle to a corresponding set of translated configuration settings for the second vehicle.

15. The system of claim 13, wherein in providing the adjusted configuration settings associated with the second vehicle to the second vehicle, the instructions cause the system to provide the mappings to the second vehicle to be translated into a set of translated configuration settings for the second vehicle.

16. The system of claim 11, wherein the first communication link and the second communication link include a wireless personal area network.

17. The system of claim 11, wherein the instructions further cause the system to:
store adjusted configuration settings associated with the second vehicle as adjusted configuration settings associated with the second vehicle in the driver profile;
receive, via the second communication link, adjusted configuration settings associated with the second vehicle; and
update the adjusted configuration settings associated with the second vehicle stored in the driver profile.

18. The system of claim 11, wherein the instructions further cause the system to:
receive, from the first vehicle, driver-specific trip summary information associated with operation of the first vehicle;
include the driver-specific trip summary information associated with operation of the first vehicle in the driver profile;
receive, from the second vehicle, driver-specific trip summary information associated with operation of the second vehicle; and
include the driver-specific trip summary information associated with operation of the second vehicle in the driver profile; and
provide the driver profile to a driver rewards system operative to reward drivers for positive driving behaviors based on an evaluation of driver-specific trip summary information associated with the driver over a plurality of time periods.

19. A method, comprising:
receiving an indication of a driver operating a first vehicle at a first time;
establishing a first communication link with a mobile computing device associated with the driver;
receiving, a driver profile including a set of adjusted configuration settings associated with a second vehicle operated by the driver;
receiving a set of mappings between configuration settings of the first vehicle and the second vehicle; and
translating the adjusted configuration settings associated with a second vehicle to a set of translated configuration settings for the first vehicle.

20. The method of claim 19, further comprising adjusting one or more configuration settings of the first vehicle based on the set of translated configuration settings for the first vehicle.
